(19) United States
(12) Patent Application Publication
(10) Pub. No.: US 2010/0131106 A1
(43) Pub. Date: May 27, 2010

(54) Method for efficient operation of cooling system

(76) Inventor: Malee Kriangkanont, Saimai (TH)

Correspondence Address: Dr. Sukanya Jesadanoni, 386/2 Ratchadaphisek 42, Chatuchak, 10900, TH

(21) Appl. No.: 12/589,723

(22) Filed: Oct. 28, 2009

(30) Foreign Application Priority Data
Oct. 30, 2008 (TH) 0801005604

(51) Int. Cl. G05B 15/00; F25B 1/00

(52) U.S. Cl. 700/275; 62/115

(57) ABSTRACT

A method for efficient operation of cooling system by using a system capable of controlling average cooling ability. The method describes controlling of injection of refrigerant ‘ON and ‘OFF’ into evaporator alternately according to preset period of time or preset differential room temperature by constructing circuits of specific arrangement of components of cooling system which are compressor, condenser, expansion valves, evaporator(s), evaporator pressure regulator, solenoid valves and/or a three-way valve. The system functions to control of the operation of air-conditioning more or less similar to those system using Inverter to control the air-conditioning system, but is a much simpler technology, easy to repair or maintain and much less expensive, in addition to be able to apply with cooling system of the Variable Refrigerant Volume (VRV) type or multi-fancoil type.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

Air-conditioner and cooling system.

2. Description of Related Art

This invention relates to efficient manipulation of cooling system(s) or air-conditioning to consume much less energy regarding when there is great change of temperature during the operation. Since upon each starting of the operation cycle of a compressor of an air-conditioner, energy is greatly consumed. Thus, too much energy is consumed unnecessarily especially at the time where there is big change and frequent change in room temperature. The thermostat is automatically off and on very frequently. The starting of the compressor is then very frequent as well, which in turn, energy is consumed much greater than really needed. To avoid such too great energy consumption during very frequent change of temperature, in prior arts, a system is developed to use the air-conditioner having the inverter compressor. Yet, the technology is too complicate, very difficult if repairing is needed, in addition to its expensive cost. The solution to such problem, the present invention describes a method for controlling of average cooling capacity of the system using, conventional compressor(s). The performance is more or less the same, but the technology is much simpler, easier for repairing and maintenance, and much cheaper. This newly invented system could be used with air-conditioning system of VRV (Variable Refrigerant Volume) type or multi-fancoil type.

### SUMMARY OF THE INVENTION

A method for efficient operation of cooling system by using a system capable of controlling average cooling ability. The method describes controlling of injection of refrigerant ‘ON and ‘OFF’ into evaporator alternately according to preset period of time or preset differential room temperature by constructing circuits of specific arrangement of components of cooling system which are compressor, condenser, expansion valves, evaporator(s), evaporator pressure regulator, solenoid valves and/or a three-way valve. The method allows efficient controlling of operation of air-conditioning more or less similar to those system using Inverter to control the air-conditioning system. The present invention discloses a method to control cooling system with a much simpler technology, easy to repair or maintain and much less expensive, in addition to be able to apply with cooling system of the Variable Refrigerant Volume (VRV) type or multi-fancoil type.

### BRIEF DESCRIPTION OF THE DRAWINGS

FIG. 1 is a conventional cooling circuit of the prior arts.

FIG. 2 shows how solenoid valves V1 and V4 are added to a standard cooling circuit.

FIG. 3 shows adding of solenoid valve V2 to the cooling circuit.

FIG. 4 shows how a three-way valve TWV1 is used instead of solenoid valves to perform the same function.

FIG. 5 is a diagram showing controlling of the system at 50% average capacity through periods of operation time.

FIG. 6 is a diagram showing controlling of the system at 75% average capacity through periods of operation time.

FIG. 7 is a diagram showing controlling of average capacity of the system through deviation or differential room temperature of 0.5° C.

FIG. 8 shows use of Evaporator Pressure Regulator (EPR) instead of solenoid valve V4 of circuit in FIG. 3.

FIG. 9 shows arrangement of circuit as a whole to be used in systems capable of averaging cooling capacity comprises sub-circuits having solenoid valve, expansion valve, evaporator and evaporator pressure regulator arranged in series to use in air-conditioning system of VRV or multi-fancoil type.

FIG. 10 shows how compressor, condenser and whole circuit of FIG. 9 are connected in series arrangement.

FIG. 11 shows circuit of FIG. 10 having solenoid valve V0 whose inlet connecting from between condenser 2 and common tubing H1, and the other end connected to expansion valve R0 whose outlet connected to in between common tubing H2 and compressor 1 to help cooling the compressor.

### DETAILED DESCRIPTION OF THE PREFERRED EMBODIMENTS

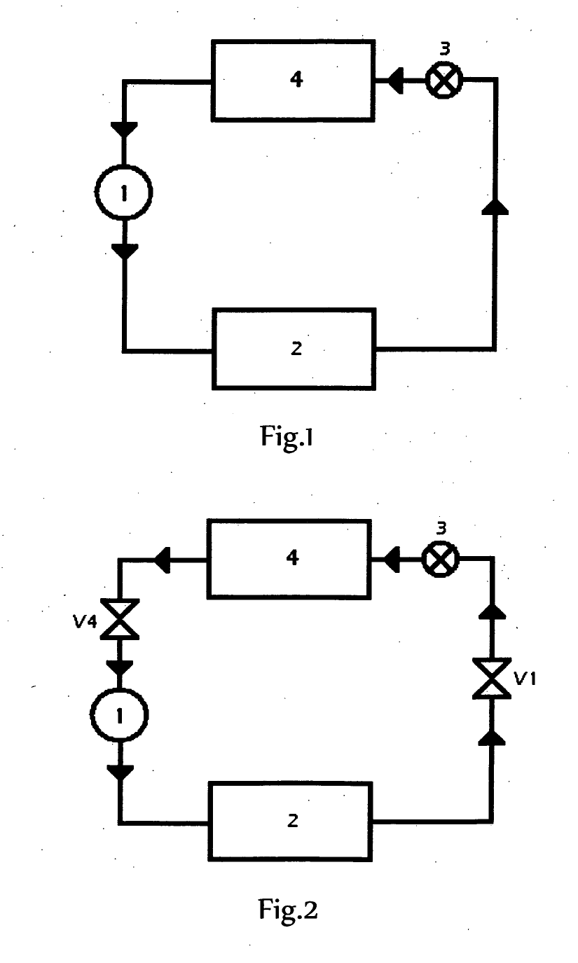

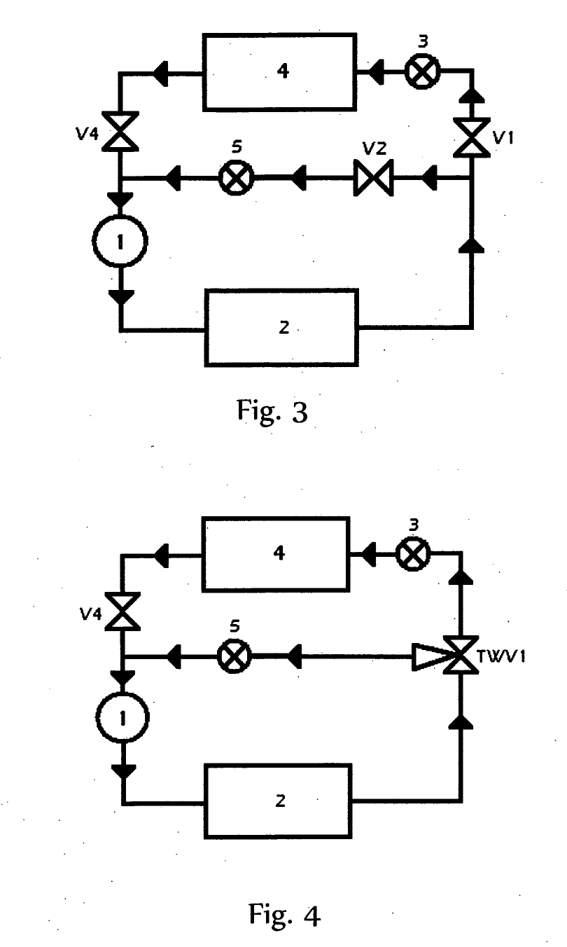

FIG. 1 shows the circuit of a conventional air-conditioning system of the prior arts where the flow of refrigerant is compressed from compressor 1 into condenser 2 and passes through expansion valve 3 and injected into evaporator 4, then back into compressor 1 to complete the circuit. For connecting a circuit of the present invention to improve the control of cooling system by means of controlling the average capacity of the system, is made as of FIG. 2 and FIG. 3 as follows:

As shown in FIG. 2, solenoid valve V1 is added in between condenser 2 and expansion valve 3, and solenoid valve V4 is placed in between evaporator 4 and compressor 1. Solenoid valves V1 and V4 are installed according to direction of the flow of refrigerant. FIG. 3 shows that solenoid valve 2 is further inserted such that its inlet is connected from between solenoid valve V1 and condenser 2 where its outlet is connected to expansion valve 5 whose outlet is connected to in between solenoid valve V4 and compressor 1.

The control is performed by controlling the turning on and off of the solenoid valves. Solenoid valves V1 and V4 is turning on and off simultaneously, but opposite to solenoid valve 2. The operation is as follows: when solenoid valves V1 and V4 are ‘ON’, solenoid valve V2 is ‘OFF’. Compressor 1 compresses refrigerant to flow through condenser 2, to solenoid valve V1 and further into expansion valve 3, to have the refrigerant fully injected into the evaporator 4, through solenoid valve V4 and then back to compressor 1 to complete the circuit. This is the condition of “FULL LOAD’ where compressor uses the maximum electrical energy. But when solenoid valves V1 and V4 are ‘OFF’, solenoid valve V2 will be ‘ON’, then there is no injection of refrigerant into evaporator 4. This is a condition of ‘NO LOAD’ where minimum electrical energy is used. The operation is alternately performed by controlling through period of operation time or through differential room temperature by presetting of a timer and/or a thermostat, respectively.

Solenoid valve V2 is ‘ON’ to allow the least volume of refrigerant to flow into expansion valve 5, yet sufficiently only to allow cooling of compressor 1. The fact is that under this ‘NO LOAD’ condition, the superheat of the system is very high that it can damage the compressor. Thus, the volume and the frequency of injection of the refrigerant need to be optimized to be the least, yet able to cool the compressor. On the other hand, too much of refrigerant can in turn harm the compressor. Control is possible thus by injection of refrigerant at all time in the system but variable where the volume of the refrigerant under ‘NO LOAD’ condition must be optimized to be the least as possible.

Control of the operation of cooling system by means of turning solenoid valve ‘ON’ and ‘OFF’ through a control system using timer or thermostat, as a result this can in turn control injection or stop injection of refrigerant into evaporator. This allows controlling the flow of refrigerant within the air-conditioning system. By varying the period or duration of turning ‘ON’ and ‘OFF’ of solenoid valves alternately for each predetermined period, this results in capability of controlling the operation of the air-conditioning system.

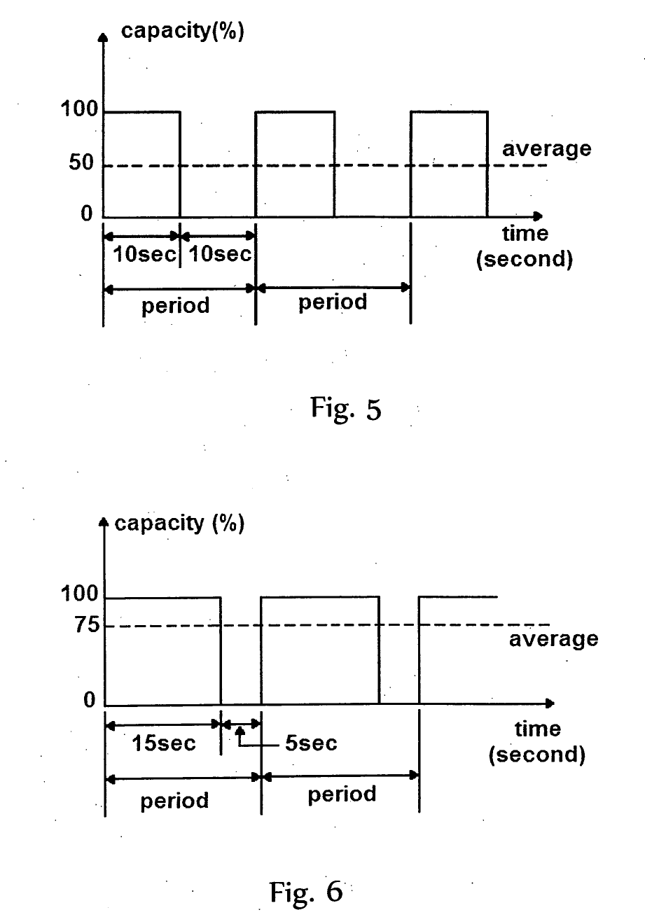

For example, as shown in FIG. 5, for each period of 20 seconds, solenoid valves V1 and V4 are turned ‘ON’ and inject refrigerant into evaporator for 10 seconds. This condition sets the system in ‘FULL LOAD’. When solenoid valves V1 and V4 are turned ‘OFF’, the system is then in ‘NO LOAD’ condition. Therefore, to average the flow rate of the refrigerant is as follows:
A period of 20 seconds, injecting refrigerant for 20 seconds, equals 100% flow rate.
A period of 20 seconds, injecting refrigerant for 10 seconds, equals 50% flow rate.

Therefore, at 50% flow rate, the average capacity of the system is controlled at 50%.

Likewise, as shown in FIG. 6, injection of refrigerant for 15 seconds of total period of 20 sec allows flow rate of 75% and results in the average capacity of 75%.

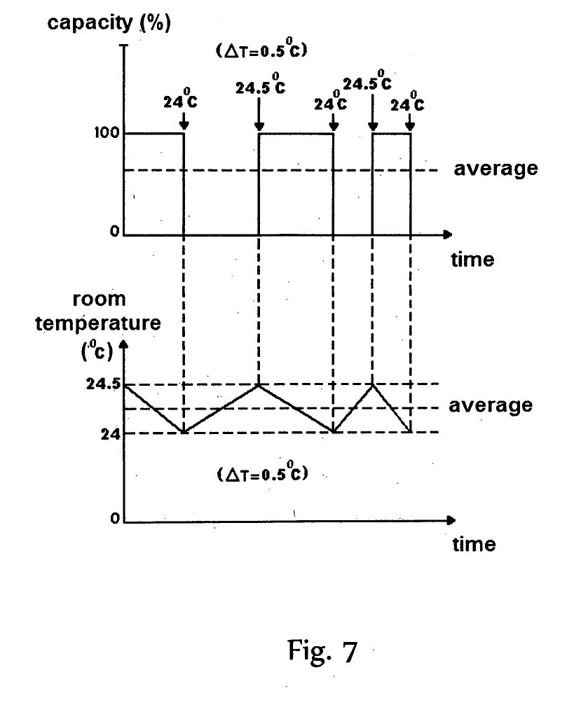

FIG. 7 shows that when room temperature is set at 24° C., having a preset differential room temperature of 0.5° C. for controlling by thermostat the turning ‘ON’ and ‘OFF’ of the solenoid valves. The process is that at the beginning, solenoid valve V2 is ‘OFF’, while solenoid valves V1 and V4 are ‘ON’, the compressor thus operates in ‘FULL LOAD’ condition. When the room temperature is down to 24° C., the controlling system turns solenoid valves V1 and V4 ‘OFF’. And V2 ‘ON’ to have the compressor in “NO LOAD’ condition. Only until the room temperature rises to 24.5° C., solenoid valve V2 is then turned ‘OFF’ and solenoid valves V1 and V4 are ‘ON’ to let the compressor back to ‘FULL LOAD’ condition. Therefore, the system is ‘ON’ and ‘OFF’ alternately to keep the fluctuation of room temperature within only 0.5° C.

Therefore, by controlling the flow rate of the refrigerant in the cooling system, it is possible to efficiently control the cooling system through the so-called its ‘average capacity’.

The operation of the system is such that, at all time of operation, there is no time point that compressor stop operating thus there is no starting of compressor at any time during operation time. This is distinctly different than that of the system utilizing inverter and thus helps energy-saving since electrical surge does not occur due to no need to start the compressor. During the operation, the capacity of the cooling system is very well controlled to meet the requirement by controlling the average flow rate operating between condition of ‘FULL LOAD’ and ‘NO LOAD’ in each period of operation. The result is that utilization of energy is controlled and optimized to meet the requirement, where during ‘FULL LOAD’ condition energy consumption is the highest and during ‘NO LOAD’ condition energy consumption is the minimum. The average value for operation can be determined similar to that of determining average capacity of the cooling system. This helps that average electrical power consumed equals to what really needed for the operation. There is no excess use of energy unnecessarily. Thus, the present invention operates similarly to the system using inverter, yet with less energy consumption, much less complicate, and easier for repairing or maintenance.

As shown in FIG. 4, removing solenoid valves V1 and V2 of circuit of FIG. 3 and a three-way valve TWV1 is put in place having its inlet connected from condenser 2 and its first outlet connected to expansion valve 3 while its second outlet connected to expansion valve 5.

Controlling of cooling system of FIG. 4 is performed as follows: solenoid V4 and first outlet of three-way valve TWV1 are ‘ON’ and ‘OFF’ at the same time but opposite to the second outlet of three-way valve TWV1. Thus, at step 1, solenoid V4 and first outlet of three-way valve TWV1 are ‘ON’. Refrigerant is compressed from compressor 1 through condenser 2 out through first outlet of three-way valve TWV1 into expansion valve 3 and fully forced into evaporator 4, then back to compressor 1 to complete the circuit. This is the condition the system operates in ‘FULL LOAD’ and energy is consumed at highest level.

In a different condition, when solenoid valve V4 is ‘OFF’ where the first outlet of three-way valve TWV1 is also ‘OFF’, the second outlet of the three-way valve TWV1 is ‘ON’ and having the refrigerant in least amount to flow through to expansion valve 5 and back to compressor 1. There is then NO refrigerant in evaporator 4. The cooling system thus operates under ‘NO LOAD’ condition, where compressor uses the least electrical. energy. The system is alternately operating depends on the rhythm of preset period or the preset differential room temperature like that of FIG. 3.

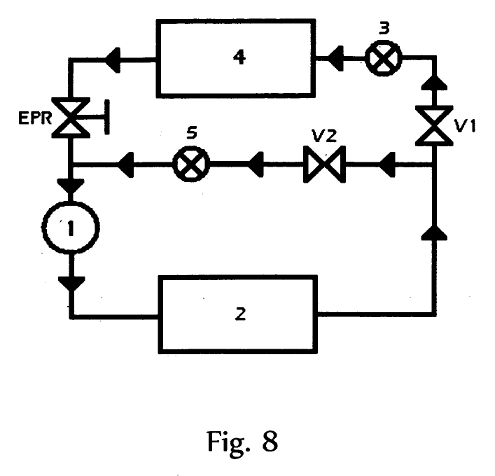

FIG. 8 shows that Evaporator Pressure Regulator (EPR) is used instead of solenoid valve V4 of circuit shown in FIG. 3, to regulate the evaporating temperature of the refrigerant (for air-conditioner the temperature for evaporating the refrigerant is about 5° C.). To regulate the pressure of refrigerant in evaporator 4, solenoid valves V1 and V2 are turning ‘ON’ and ‘OFF’ oppositely. In the first step, solenoid valve V1 is ‘ON’ while solenoid valve V2 is ‘OFF’. This allows the cooling system to operate under ‘FULL LOAD’ condition. When solenoid valve V1 is ‘OFF’, solenoid valve V2 is then ‘ON’ and let the system operate under ‘NO LOAD’ condition. As solenoid. valve V2 is ‘ON’, refrigerant in least volume flows into expansion valve 5 to cool compressor 1. The system operates alternately depends on the preset period of operation or the preset differential room temperature in the same manner as that of FIG. 3.

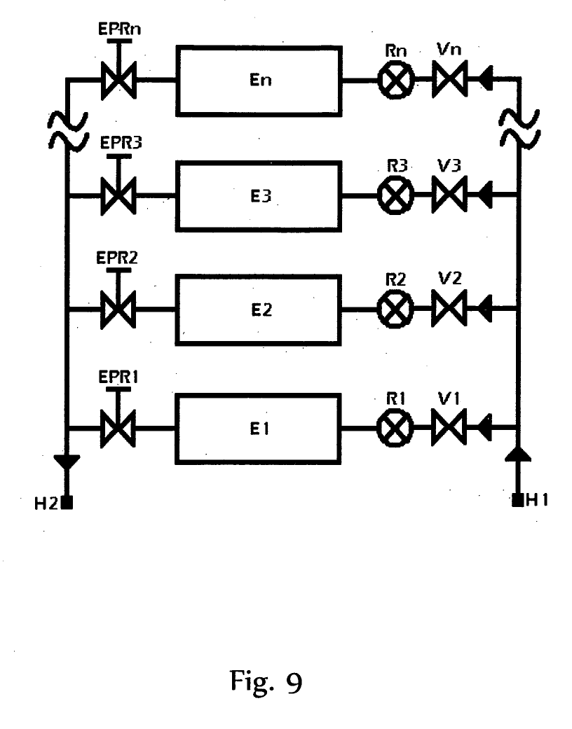

FIGS. 9, 10 and 11 show the process utilizing this invented cooling system with averaging capacity described in the present invention to apply with VRV type or multi-fancoil type, where one condensing unit can be connected to 2 units of fancoil and up. Each unit operates independently depending on the load of each unit as follows:

In FIG. 9, many fancoils are connected in parallel, each sub-circuit is connected in parallel where each sub-circuit consists of components arranged in series according to flow direction of the refrigerant. In sub-circuit No. 1, refrigerant flows through solenoid valve V1 into expansion valve R1 which injects refrigerant fully into evaporator E1 and out through evaporator pressure regulator EPR1. For sub-circuit No. 2, refrigerant flows through solenoid valve V2 into expansion valve R2 which injects refrigerant fully into evaporator E2 and out through evaporator pressure regulator EPR2. For sub-circuit No. n, refrigerant flows through solenoid valve Vn into expansion valve Rn which injects refrigerant fully into evaporator En and out through evaporator pressure regulator, EPRn. The sub-circuits are arranged in parallel where refrigerant flows in to the side of solenoid valve Vn from a common tubing called Header 1, H1. Refrigerant flows out from evaporator pressure regulator, EPRn to pool into a common tubing called Header 2, H2.

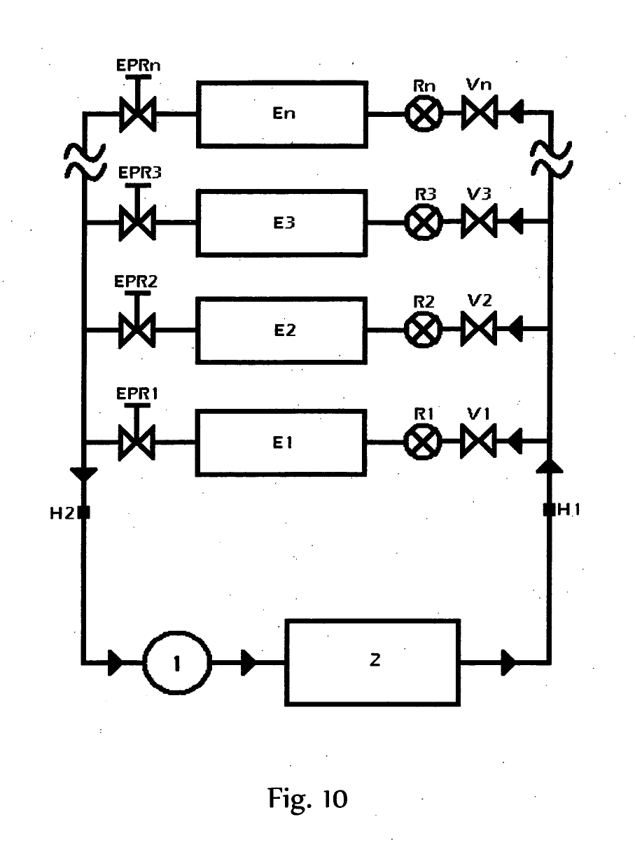

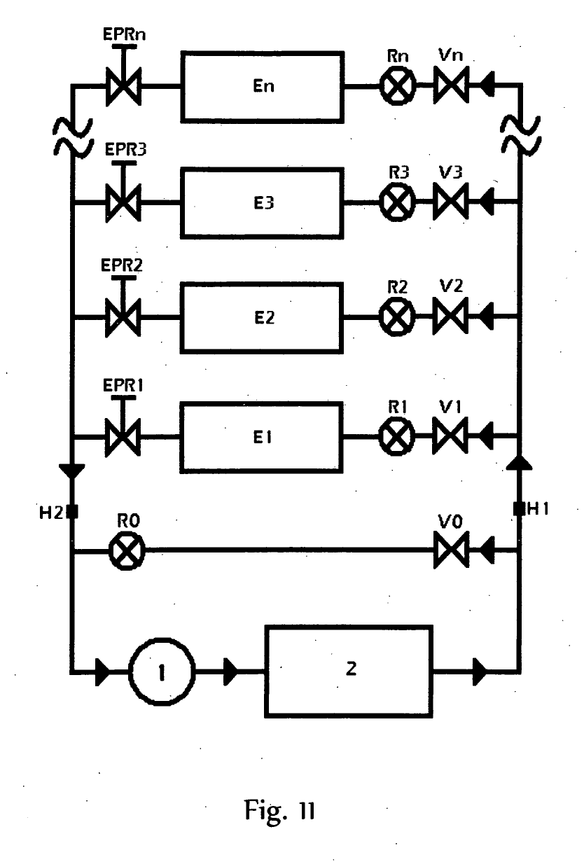

As shown in FIG. 10, inlet of compressor 1 is connected to common tubing H2, and condenser 2 is connected between tubing from compressor 1 and common tubing H1, thus makes the main circuit complete. According to FIG. 11, inlet of solenoid valve V0 is connected from between common tubing H1 and condenser 2, where its outlet connected to expansion valve R0 and outlet of expansion valve R0 is connected in between common tubing H2 and compressor 1. Therefore, the air-conditioning system of multi-fancoil is thus equipped with the controlling system capable of averaging the cooling ability to keep the temperature under control.

The operation starts with compressor 1 compresses the refrigerant from all evaporators fully into condenser 2, the refrigerant flows into common tubing H1, and distributed into each sub-circuit at all time that solenoid valve Vn is ‘ON’. Each sub-circuit operates independently within its sub-circuit. The size of each fancoil depends on the ‘LOAD’ it assigned which needs not be equal for all the sub-circuits. The size of each expansion valve Rn is equal and sufficient to inject refrigerant fully into evaporator En which is the volume for ‘FULL LOAD’ operation of its sub-circuit. The evaporator pressure regulator, EPRn, functions by regulating the pressure within the evaporator En to be constant to have the evaporating temperature is as preset. For instance, air-conditioner set the evaporating temperature at about 5° C. The operation of the main circuit is the summing up of the operation of all the sub-circuit. The capacity of compressor 1 thus equals to the capacity at ‘FULL LOAD’ condition of all the fan coils summed up. Condenser 2 must have the size big enough to cool down the heat results from operation at ‘FULL LOAD’ condition of compressor 1 summed up with the heat of compressor 1 itself.

The operation of each sub-circuit is possible independently by controlling the turning ‘ON’ and ‘OFF’ of solenoid valve Vn in each sub-circuit according to the preset period of operation or the preset differential room temperature (ΔT). Yet independency of each sub-circuit results in superheating and can damage compressor 1. When superheating occurs, the solenoid valve V0 thus must turn ‘ON’ to inject optimum volume of refrigerant through expansion valve R0 to cool compressor 1 efficiently and prevent compressor 1 from being damaged (yet the optimal volume must be used as too much will also harm the compressor). Alternatively, solenoid valve V0 is controlled to be ‘ON’ at all time where very small amount of refrigerant is used and easy to regulate.

As a result, average capacity of each sub-circuit can be controlled by using only one condensing unit and compressor at least one unit. As a result, air-conditioning system of VRV type or multi-fancoil type can use this system of average cooling capacity to control the system much simpler, easier for repairing and maintenance, and much cheaper than the inverter compressor.

It will be understood that modifications can be made in the above description without departing from the scope of this invention by one of ordinary skill in the art. It is accordingly intended that all matter contained in the above description be interpreted as descriptive and illustrative rather than in a limiting sense. It is also to be understood that the following claims are intended to cover all of the generic and specific features of the invention as described herein, and all statements of the scope of the invention which, as a matter of language, might be said to fall therebetween.

I claim:

1. A method for efficient controlling a cooling system or air-conditioner by arranging the components of the cooling circuit according to flow of refrigerant as follows: a compressor (1), a condenser (2), a first solenoid valve (V1), a first expansion valve (3), evaporator (4), a second solenoid valve (V4) where refrigerant was compressed by compressor to flow into condenser, and out through solenoid valve (V1), expansion valve (3) evaporator (4), solenoid valve (V4) and back to compressor (1) and where use of said second solenoid valve (V4) is optional;
adding a third solenoid valve (V2) and a second expansion valve (5) to the circuit where inlet of said solenoid valve (V2) connected from between condenser (2) and solenoid valve (V1) and outlet of said solenoid valve (V2) connected to expansion valve (5), outlet of expansion valve (5) connected to between solenoid valve (V4) and compressor (1).

2. A method for efficient controlling a cooling system or air-conditioner of claim 2 where operating of cooling system is possible under ‘FULL LOAD’ condition or ‘NO LOAD’ condition
where the operation of ‘FULL LOAD’ condition comprises steps of:
compressing refrigerant from compressor (1) to flow into condenser (2) and out to said first solenoid valve (V1) which is in ‘ON’ position into expansion valve (3) to inject the refrigerant fully into evaporator (4) and out through second solenoid valve (V4) in ‘ON’ position and back to compressor (1) while the third solenoid valve (V2) is in ‘OFF’ position; and,
where the operation of ‘NO LOAD’ condition comprises steps of:
compressing refrigerant from compressor (1) to flow into condenser 2 and out to said third solenoid valve (V2) in ‘ON’ position and into said second expansion valve (5) to inject the least optimum amount of refrigerant enough to cool into compressor (1); while first and second solenoid valves (V1 and V4) are in ‘OFF’ position and no refrigerant flows into evaporator (4) to allow ‘NO LOAD’ condition;
where turning ‘ON’ and ‘OFF’ of solenoid valves is under control according to preset time period or preset differential room temperature through a timer or a thermostat.

3. A method for efficient controlling a cooling system or air-conditioner where in said cooling circuit of claim 2, a three-way valve (TWV1) is used instead of said first solenoid valve (V1) and said third solenoid valve (V2), and where the inlet of said three-way valve (TWV1) connecting from said condenser (2) and its first outlet connecting to first expansion valve (3) and its second outlet connecting to second expansion valve (5) and operation is performed that said first outlet connected to expansion valve (3) and solenoid valve (V4) turn ‘ON’ and ‘OFF’ at the same time but opposite to second outlet connected to said second expansion valve (5), where turning on and off of the components are controlled by timer or thermostat.

4. Method of claim 2 where an evaporator pressure regulator (EPR) substitutes said second solenoid valve (V4) or used in addition to said second solenoid valve (V4) whose position can be either before or after said second solenoid valve (V4) to connect with system controlling injection of refrigerant.

5. A method for efficient controlling a cooling system or air-conditioner where sub-circuit is constructed according to direction of flow of refrigerant consisting of solenoid valve (Vn), expansion valve (Rn), evaporator En and evaporator pressure regulator (EPRn) arranged in series, and where many sub-circuit are connected in parallel to make a main circuit having refrigerant flows into each inlet of solenoid valve (Vn) from a first common tubing (H1), and flows out from each evaporator pressure regulator (EPRn), into a second common tubing (H2), to flow back into compressor(s) to be compressed into a condenser.

6. A method for efficient controlling a cooling system or air-conditioner of claim 5 is further modified where inlet of an additional solenoid valve (V0) is connected from between condenser and said first common tubing (H1) and outlet. is connected to a expansion valve (R0) whose outlet is connected to between said second common tubing (H2) and compressor, where each sub-circuit operates independently and controlled by turning on and off the injection of refrigerant by turning on and off solenoid valve using timer or thermostat, where the circuit are applied to a cooling system or for air-conditioning system of Variable Refrigerant Volume (VRV) type or multi-fancoil type.

7. A system for efficient controlling a cooling system or air-conditioner constructed by arranging the components of the cooling circuit according to flow of refrigerant as follows: a compressor (1), a condenser (2), a first solenoid valve (V1), a first expansion valve (3), evaporator (4), a second solenoid valve (V4) where refrigerant was compressed by compressor to flow into condenser, and out through solenoid valve (V1), expansion valve (3) evaporator (4), solenoid valve (V4) and back to compressor (1), and where use of said second solenoid valve (V4) is optional;
adding a third solenoid valve (V2) and a second expansion valve (5) to the circuit where inlet of said solenoid valve (V2) connected from between condenser (2) and solenoid valve (V1) and outlet of said solenoid valve (V2) connected to expansion valve (5), outlet of expansion valve (5) connected to between solenoid valve (V4) and compressor (1);
adding timer and/or thermostat to control the turning ‘ON’ and ‘OFF’ of said solenoid valves.
